(19) United States
(12) Patent Application Publication
(10) Pub. No.: US 2009/0142482 A1
(43) Pub. Date: Jun. 4, 2009

(54) Methods of Printing Conductive Silver Features

(75) Inventors: Yuning LI, Mississauga (CA); Ping LIU, Mississauga (CA); Yiliang WU, Mississauga (CA); Hualong PAN, Hamilton (CA); Paul F. SMITH, Oakville (CA); Hadi K. MAHABADI, Mississauga (CA)

Correspondence Address: OLIFF & BERRIDGE, PLC., P.O. BOX 320850, ALEXANDRIA, VA, 22320-4850, US

(73) Assignee: XEROX CORPORATION, Norwalk, CT (US)

(21) Appl. No.: 11/948,509

(22) Filed: Nov. 30, 2007

(51) Int. Cl. B05D 5/12

(52) U.S. Cl. 427/125

(57) ABSTRACT

A method of forming a conductive ink silver features on a substrate by printing a silver compound solution and a hydrazine compound reducing agent solution on the surface of a substrate with a printhead. The silver compound solution and the hydrazine compound reducing agent solution are mixed just before, during, or following the printing of both solutions on the surface of the substrate, and the silver compound is then reduced to form conductive silver ink features on the substrate.

### BACKGROUND

Fabrication of electronic circuit elements using liquid deposition techniques is of profound interest as such techniques provide potentially low-cost alternatives to conventional mainstream amorphous silicon technologies for electronic applications such as thin film transistors (TFTs), light-emitting diodes (LEDs), RFD tags, photovoltaics, etc. However, the deposition and/or patterning of functional electrodes, pixel pads, and conductive traces, lines and tracks which meet the conductivity, processing and cost requirements for practical applications have been a great challenge. Silver is of particular interest as conductive elements for electronic devices because silver is much lower in cost than gold and it possesses much better environmental stability than copper. There is therefore a need, addressed by embodiments herein, for lower cost methods for preparing liquid processable, stable silver compositions that are suitable for fabricating electrically conductive elements of electronic devices.

Solution-processable conductors are of great interest for printed electronic applications as electrodes, conducting lines in thin film transistors, RFID tags, photovoltaics, etc. Silver nanoparticle-based conductive inks represent a promising class of materials for printed electronics. However, most silver nanoparticles require large molecular weight stabilizers to ensure proper solubility and stability. These large molecular weight stabilizers inevitably raise the annealing temperatures of the silver nanoparticles above 200° C. in order to remove the stabilizers, which temperatures are incompatible with most plastic substrates and can cause damage or deformation thereto.

Further, the use of lower molecular weight stabilizers can also be problematic, as smaller size stabilizers often do not provide desired solubility and often fail to effectively prevent coalescence or aggregation of the silver nanoparticles before use.

One of the advantages achieved by embodiments herein is that the printing does not require the use of any stabilizer as in the case of other similar procedures using silver nanoparticles. As a result, stable solutions for printing are obtained, and also the post printing thermal annealing can be eliminated or conducted at ambient temperature or at temperatures much lower than 200° C. due to the absence of any stabilizer, particularly high molecular weight stabilizers. This opens up the possibility of printing the silver features on additional substrates that previously could not withstand high annealing temperatures, for example, of 200° C. or more.

### SUMMARY

The present application thus achieves advances over prior procedures for printing silver features on a substrate and discloses an in situ process to form conductive silver features by printing two or multiple components onto a substrate. Upon combining the components together, these two or multiple components react with each other to form conductive silver features. The two or multiple components contain at least one silver compound, at least one hydrazine compound reducing agent, and optionally other components.

Thus, described in embodiments is a method of forming a conductive silver feature on a substrate, the method comprising: providing two or more solutions, wherein a first solution is a silver compound solution and a second solution is a reducing agent solution comprised of a hydrazine compound for the silver compound, the hydrazine compound reducing agent solution being separate from the silver compound solution; printing the silver compound solution and the hydrazine compound reducing agent solution onto the substrate with a printhead, wherein just before printing, during printing, or following the printing of both the silver compound solution and the hydrazine compound reducing agent solution onto the substrate, the silver compound solution and the hydrazine compound reducing agent solution are combined; and reducing the silver compound to form the printed silver feature on the substrate.

In further embodiments is described a method of forming a conductive silver feature on a substrate, the method comprising: providing two or more solutions, wherein a first solution is a silver compound solution and a second solution is a reducing agent solution comprised of a hydrazine compound for the silver compound, the hydrazine compound reducing agent solution being separate from the silver compound solution; just before printing the silver compound solution and the hydrazine compound reducing agent solution onto the substrate, the silver compound solution and the hydrazine compound reducing agent solution are combined; printing the combined solutions onto the substrate with a printhead; and reducing the silver compound to form the printed silver feature on the substrate.

In still further embodiments is described a method of forming a conductive silver feature on a substrate, the method comprising: providing two or more solutions, wherein a first solution is a silver compound solution and a second solution is a reducing agent solution comprised of a hydrazine compound for the silver compound, the hydrazine compound reducing agent solution being separate from the silver compound solution; printing the silver compound solution and the hydrazine compound reducing agent solution onto the substrate with a printhead, wherein during printing or following the printing of both the silver compound solution and the hydrazine compound reducing agent solution onto the substrate, the silver compound solution and the hydrazine compound reducing agent solution are combined; and reducing the silver compound to form the printed silver feature on the substrate.

### BRIEF DESCRIPTION OF THE DRAWINGS

FIG. 1 illustrates an embodiment where the silver compound solution and the hydrazine compound reducing agent solution are combined in a microfluid reactor or mixer, transferred together to a print head for printing, delivered to a printhead by a feed lines connected to the printhead and printed on the substrate.

FIG. 2 illustrates an embodiment where the silver compound solution and the hydrazine compound reducing agent solution are transferred to the same or separate printheads by feed lines connected to the printhead and simultaneously printed onto the substrate to form conductive silver features.

FIG. 3 illustrates an embodiment where the first solution, either the silver compound solution or the hydrazine compound reducing agent solution, is printed onto the substrate and the second solution is thereafter printed consecutively onto the first solution, in the same pattern, from the same or different printheads.

### EMBODIMENTS

The printing can be implemented by using a printer. which has two or more reservoirs, a first reservoir containing a silver compound solution, and a second reservoir containing a hydrazine compound reducing agent solution, with other optional components being present in the first, second and/or additional reservoirs. Printing may be effected from the reservoirs simultaneously or consecutively from one or more printheads onto a substrate. The silver compound and the hydrazine compound reducing agent combine just before, during or after printing on the substrate and react to form the silver features in the printed pattern on the substrate. After printing, the substrate can be optionally heated to facilitate the reduction of silver compound and/or to remove any by-products from the reduction.

The printing may be implemented by using a printer with the print head connected to a microfluid reactor or mixer where the aforementioned two or more components from respective reservoirs are reacted or mixed just before being fed to the printhead for printing. The product mixture is then transferred to the printhead and printed onto the substrate. After printing, the substrate may optionally be heated to facilitate the reduction of silver compound and/or to remove any by-products from the reduction.

The silver compound solution herein includes a silver compound in a liquid system. The silver compound may include any suitable organic or inorganic silver compound. In embodiments, the silver compound may include silver oxide, silver nitrate, silver nitrite, silver carboxylate, silver acetate, silver carbonate, silver perchlorate, silver sulfate, silver chloride, silver bromide, silver iodide, silver trifluoroacetate, silver phosphate, silver trifluoroacetate, silver benzoate, silver lactate or combinations thereof.

As the liquid system, any suitable liquid or solvent may be used for the silver compound solution, including, for example, organic solvents and water. For example, the liquid solvent may comprise water, an alcohol such as, for example, methanol, ethanol, propanol, butanol, pentanol, hexanol, heptanol, octanol; a hydrocarbon such as, for example, pentane, hexane, cyclohexane, heptane, octane, nonane, decane, undecane, dodecane, tridecane, tetradecane, toluene, xylene, mesitylene, tetrahydrofuran, chlorobenzene, dichlorobenzene, trichlorobenzene, acetonitrile, or combinations thereof.

One, two, three or more solvents may be used in the silver compound solution. In embodiments where two or more solvents are used, each solvent may be present at any suitable volume ratio or weight ratio such as, for example, from about 99 (first solvent):1 (second solvent) to about 1 (first solvent):99 (second solvent).

The amount of the solvent in the silver compound solution is, for example, from about 10 weight percent to about 98 weight percent, from about 50 weight percent to about 90 weight percent or from about 60 weight percent to about 85 weight percent of the total solution weight. The concentration of the silver compound in the silver compound solution may be, for example, from about 2 weight percent to about 90 weight percent, from about 5 weight percent to about 80 weight percent, from about 10 weight percent to about 60 weight percent, or from about 15 weight percent to about 50 weight percent, of the solution.

The hydrazine compound reducing agent solution herein includes a hydrazine compound in a liquid system. As used herein, the term “hydrazine compound” refers to, for example, substituted hydrazines or their suitable hydrates or salts. The substituted hydrazine may contain from about 1 carbon atom to about 30 carbon atoms, from about I carbon atom to about 25 carbon atoms, from about 2 to about 20 carbon atoms and from about 2 to about 16 carbon atoms. In embodiments, the substituted hydrazine may include, for example, a hydrocarbyl hydrazine, a hydrazide, a carbazate and a sulfonohydrazide.

The use of a hydrazine compound as a reducing agent may have a number of advantages, such as, for example, 1) having solubility in water, polar or non-polar organic solvents depending on the substitution; 2) having strong to weak reducing ability depending on the substitution; and 3) nonexistence of non-volatile metal ions as in other reducing agents such as, for example, sodium hydroboride, which would facilitate the removal of by-product or unreacted reducing agent.

Examples of hydrocarbyl hydrazine include, for example, RNHNH₂, RNHNHR′ and RR′NNH₂, where one nitrogen atom is mono- or di-substituted with R or R′, and the other nitrogen atom is optionally mono- or di-substituted with R or R′, where each R or R′ is a hydrocarbon group. Examples of hydrocarbyl hydrazines include, for example, methylhydrazine, tert-butylhydrazine, 2-hydroxyethylhydrazine, benzylhydrazine, phenylhydrazine, tolylhydrazine, bromophenylhydrazine, chlorophenylhydrazine, nitrophenylhydrazine, 1,1-dimethylhydrazine, 1,1-diphenylhydrazine, 1,2-diethylhydrazine, and 1,2-diphenylhydrazine.

Unless otherwise indicated, in identifying the substituents for R and R′ of the various hydrazine compounds, the phrase “hydrocarbon group” encompasses both unsubstituted hydrocarbon groups and substituted hydrocarbon groups. Unsubstituted hydrocarbon groups may include any suitable substiuent such as, for example, a hydrogen atom, a straight chain or branched alkyl group, a cycloalklyl group, an aryl ,group, an alkylaryl group, arylalkyl group or combinations thereof: Alkyl and cycloalkyl substituents may contain from about 1 to about 30 carbon atoms, from about 5 to 25 carbon atoms and from about 10 to 20 carbon atoms. Examples of alkyl and cycloalkyl substituents include, for example, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, or eicosanyl, and combinations thereof. Aryl groups substituents may contain from about 6 to about 48 carbon atoms, from about 6 to about 36 carbon atoms, from about 6 to about 24 carbon atoms. Examples of aryl substituents include, for example, phenyl, methylphenyl (tolyl), ethylphenyl, propylphenyl, butylphenyl, pentylphenyl, hexylphenyl, heptylphenyl, octylphenyl, nonylphenyl, decylphenyl, undecylphenyl, dodecylphenyl, tridecylphenyl, tetradecylphenyl, pentadecylphenyl, hexadecylphenyl, heptadecylphenyl, octadecylphenyl, or combinations thereof. Substituted hydrocarbon groups may be the unsubstituted hydrocarbon groups described herein which are substituted with one, two or more times with, for example, a halogen (chlorine, fluorine, bromine and iodine), a nitro group, a cyano group, an alkoxy group (methoxyl, ethoxyl and propoxy), or heteroaryls. Examples of heteroaryls groups may include thienyl, furanyl, pyridinyl, oxazoyl, pyrroyl, triazinyl, imidazoyl, pyrimidinyl, pyrazinyl, oxadiazoyl, pyrazoyl, triazoyl, thiazoyl, thiadiazoyl, quinolinyl, quinazolinyl, naphthyridinyl, carbazoyl, or combinations thereof.

Examples of hydrazine compounds may include, for example, hydrazides, RC(O)NHNH₂ and RC(O)NHNHR′ and RC(O)NHNHC(O)R, where one or both nitrogen atoms are substituted by an acyl group of formula RC(O), where each R is independently selected from hydrogen and a hydrocarbon group, and one or both nitrogen atoms are optionally mono- or di-substituted with R′, where each R′ is an independently selected hydrocarbon group. Examples of hydrazide may include, for example, formic hydrazide, acethydrazide, benzhydrazide, adipic acid dihydrazide, carbohydrazide, butanohydrazide, hexanoic hydrazide, octanoic hydrazide, oxamic acid hydrazide, maleic hydrazide, N-methylhydrazinecarboxamide, and semicarbazide.

Examples of hydrazine compounds may include, for example, carbazates and hydrazinocarboxylates, for example, ROC(O)NHNHR′, ROC(O)NHNH₂ and ROC(O)NHNHC(O)OR, where one or both nitrogen atoms are substituted by an ester group of formula ROC(O), where each R is independently selected from hydrogen and a hydrocarbon group, and one or both nitrogen atoms are optionally mono- or d,-substituted with R′, where each R′ is an independently selected hydrocarbon group. Examples of carbazate may include, for example, methyl carbazate (methyl hydrazinocarboxylate), ethyl carbazate, butyl carbazate, benzyl carbazate, and 2-hydroxyethyl carbazate.

Examples of sulfonohydrazides include, for example, RSO₂NHNH₂, RSO₂NHNHR′, and RSO₂NHNHSAO₂R, where one or both nitrogen atoms are substituted by a sulfonyl group of formula RSO₂, where each R is independently selected from hydrogen and a hydrocarbon group, and one or both nitrogen atoms are optionally mono- or di-substituted with R′, where each R′ is an independently selected hydrocarbon group. Examples of sulfonohydrazide may include, for example, methanesulfonohydrazide, benzenesulfonohydrazine, 2,4,6-trimethylbenzenesulfonohydrazide, and p-toluenesulfonohydrazide.

Other hydrazine compounds may include, for example, aminoguanidine, thiosemicarbazide, methyl hydrazinecarbimidothiolate, and thiocarbohydrazide.

Any suitable liquid or solvent may be used for the hydrazine compound reducing agent solution, including, for example, organic solvents and water. The liquid organic solvent may comprise, for example, an alcohol such as methanol, ethanol, propanol, butanol, pentanol, hexanol, heptanol, octanol, a hydrocarbon solvent such as pentane, hexane, cyclohexane, heptane, octane, nonane, decane, undecane, dodecane, tridecane, tetradecane, toluene, xylene, mesitylene, tetrahydrofuran; chlorobenzene; dichlorobenzene; trichlorobenzene; nitrobenzene; cyanobenzene; acetonitrile; alcohols, or mixtures thereof.

The weight percentage of solvent in the hydrazine compound reducing agent solution is, for example, from about 0 weight percent to about 95 weight percent, from about 20 weight percent to about 80 weight percent or from about 30 weight percent to about 60 weight percent of the total solution weight. The concentration of the hydrazine compound in the reducing agent solution may be, for example, from about 1 weight percent to about 100 weight percent, from about 5 weight percent to about 80 weight percent, from about 10 weight percent to about 60 weight percent, or from about 15 weight percent to about 50 weight percent, of the solution.

One, two, three or more solvents may be used in the hydrazine compound reducing agent solution. In embodiments where two or more solvents are used, each solvent may be present at any suitable volume ratio or weight ratio such as, for example, from about 99 (first solvent): 1 (second solvent) to about 1 (first solvent):99 (second solvent).

Additional optional components may also be added to the silver compound solution. The additional components can include an amine such as, for example, methylamine, ethylamine, propylamine, butylamine, pentylamine, hexylamine, heptylamine, octylamine, nonylamine, decylamine, undecylamine, dodecylamine, hexadecylamine, oleylamine, ethanolamine, propanolamine, dimethylamine, dipropylamine, diburylamine, dihexylamine, triethylamine, tributylamine, trihexylamine, ethylenediamine, N,N,N′,N′-tetramethylethylenediamine, and the like; an ammonium carbamate such as, for example, ethylammonium ethylcarbamate, propylammonium propylcarbamate, butylammonium butylcarbamate, pentylammonium pentylcarbamate, hexylammonium hexylcarbamate, and the like; a carboxylic acid such as, for example, acetic acid, propionic acid, butyric acid, pentanoic acid, hexanoic acid, heptanoic acid, octanoic acid, nonanoic acid, decanoic acid, undecanoic acid, dodecanoic acid, tridecanoic acid, myristic acid, pentadecanoic acid, palmitic acid, heptadecanoic acid, stearic acid, oleic acid, nonadecanoic acid, icosanoic acid, cicosenoic acid, elaidic acid, linoleic acid, pamitoleic acid, and the like; a polymer such as, for example, polyethyleneoxide, polystyrene, polyvinylpyridine, polyvinylpyrilidone, polymethylmethacrylate, polyethyleneamine, and the like.

To effect the reduction of the silver compound, the silver compound solution and the hydrazine compound reducing agent solution are combined just prior to printing, during printing or after printing. The combining may be by any suitable method, including mixing. The amount of hydrazine compound reducing agent solution to mix with the silver compound should be sufficient to substantially to completely reduce the silver compound to silver. It may be desirable to employ excess reducing agent solution to ensure substantially complete to complete reduction of the silver compound. Thus, for example, the silver compound solution to hydrazine compound reducing agent solution mixing ratio may be from 1 molar equivalent silver compound to about 0.5 to 2 molar equivalent reducing agent.

In embodiments, the silver compound solution and the hydrazine compound reducing agent solution are stored in reservoirs or cartridges, connected by feed lines to one or more printheads. In this manner, the silver compound solution and the hydrazine compound reducing agent solution may be delivered to printhead(s) for deposition onto a substrate. As a result, silver features may be readily printed onto the substrate.

In embodiments, the silver compound solution and the hydrazine compound reducing agent solution are combined in a mixer or reactor just before printing. As used herein, “just before printing” refers to, for example, the silver compound solution and hydrazine compound reducing agent solution being combined prior to being transferred together to a print head for printing, under time conditions such that the reduction reaction substantially does not occur, such as for about 0.05 seconds to about 5 minutes before printing, for example, for about 0.2 seconds to about 1 minute before printing or for about 0.3 seconds to about 5 seconds before printing.

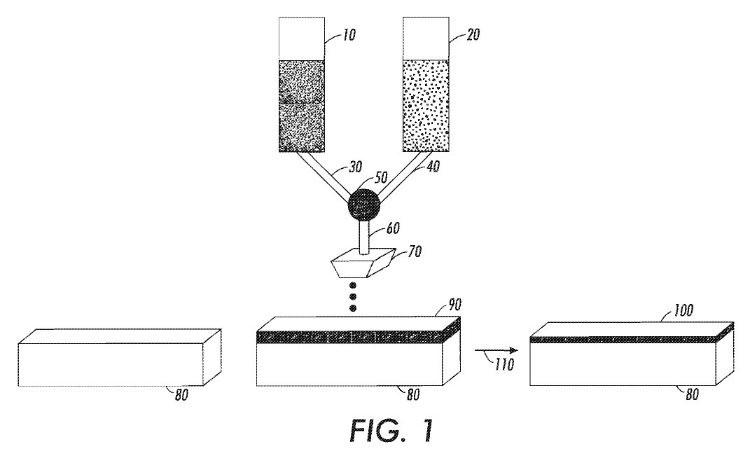

This embodiment is further described by way of illustration in FIG. 1. In FIG. 1, the silver compound solution (10) and the hydrazine compound reducing agent solution (20) are transferred to the microfluid reactor or mixer (50) by the silver compound solution transfer line (30) and the hydrazine compound reducing agent solution transfer line (40). Both solutions are then combined in a microfluid reactor or mixer (50) prior to being by transferred together to a print head (70) for printing. The combined solution is delivered to a printhead (70) by a feed lines (60) connected to the printhead (70). Finally, the combined solution is deposited on the substrate (80). As a result, silver features (90) are printed on the substrate. A conductive silver film (100) is then formed with or without thermal annealing and/or washing (110).

As the mixer herein, any suitable device may be used. The solution may be fed from the respective reservoirs to the mixer and discharged from the mixer to the printhead. The mixer can be any mixing device such as a microfluid reactor or mixer such as, for example, a microfluid reactor or mixer available from Syrris, Inc.

In embodiments, the silver compound solution and the hydrazine compound reducing agent solution are transferred to the same or separate printheads and combined during the printing of both the silver compound solution and the hydrazine compound reducing agent solution onto the substrate. In the case of printing separately the silver compound solution and the hydrazine compound reducing agent, the order of printing the two components can be i) first printing the silver compound solution and then the hydrazine compound reducing agent solution; or ii) first printing the hydrazine reducing agent solution and then the silver compound solution. As used herein, “during printing” refers to, for example, the silver compound solution and the hydrazine compound reducing agent solution being printed simultaneously onto the substrate from the same or different printheads, and thus that the respective solutions effectively combine during printing onto the substrate, even though the bulk of the reduction reaction may occur following printing onto the substrate.

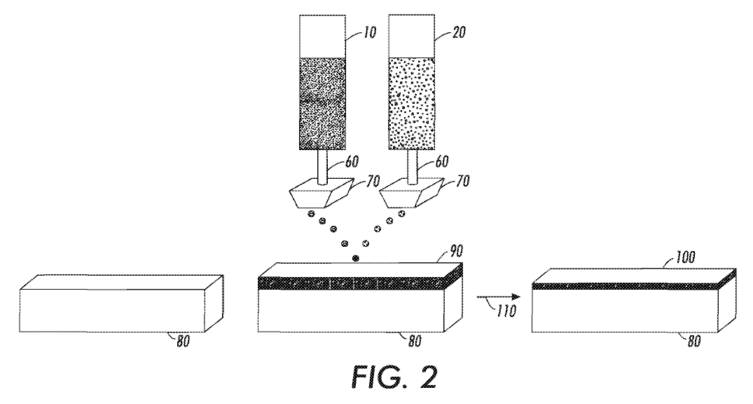

As a way of illustrating this embodiment, FIG. 2, for convenience, displays the silver compound solution and hydrazine compound reducing agent solution being printed by separate printheads. In FIG. 2, the silver compound solution (10) and hydrazine compound reducing agent solution (20) are transferred to separate printheads (70) by feed lines (60) connected to the printheads (70). Both solutions are simultaneously printed onto the substrate (80) to form silver features (90). A conductive silver film (100) is then formed with or without thermal annealing and/or washing (110).

In embodiments, the silver compound solution and the hydrazine compound reducing agent solution are combined on the substrate after first printing one of the solutions and thereafter subsequently printing the second solution onto the first solution. As used herein, “after printing” refers to, for example, the silver compound solution and the hydrazine compound reducing agent solution being printed consecutively onto the substrate from the same or different printheads.

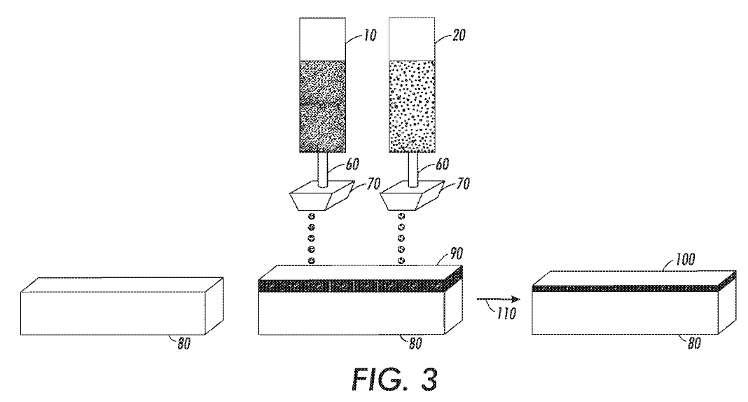

As a way of illustrating this embodiment, FIG. 3, for convenience, displays the silver compound solution and hydrazine compound reducing agent solution being printed by separate printheads. In FIG. 3, the silver compound solution (10) is transferred to the silver compound solution's printhead (70) by a feed line (60) and printed onto the substrate (80). The hydrazine compound reducing agent solution (20) is subsequently transferred to its printhead (70) by a feed line (60) and printed consecutively onto the substrate (80) with the previously printed silver solution (10) to form silver features (90). The solutions are thus printed in the same pattern onto the substrate (80) in sequential order to form a conductive silver film (100) with or without thermal annealing and/or washing (110).

The substrate to have the conductible silver features printed thereon may then be heated or washed with a solvent to remove any remaining residual solvent and/or by-products from the reaction of the silver compound solution and the hydrazine compound reducing agent solution. In embodiments, the substrate containing the combined solutions of silver compound and hydrazine compound reducing agent may be optionally heated during or following printing to a temperature of, for example, from about room temperature to about 200° C., such as from about 40° C. to about 180° C., or from about 50° C. to about 150° C., to facilitate the reduction of silver compound and/or remove reduction by-products.

The fabrication processes described herein desirably do not include the use of any stabilizer in either of the silver compound or hydrazine compound reducing agent solutions, as is typically the case with printing solutions containing silver nanoparticles.

Any suitable liquid or solvent may be used to wash the conductive silver features to remove any residual solvent and/or by-products from the reaction of the silver compound solution and the hydrazine compound reducing agent solution, such as, for example, organic solvents and water. For example, the solvent may comprise, for example, hydrocarbon solvents such as pentane, hexane, cyclohexane, heptane, octane, nonane, decane, undecane, dodecane, tridecane, tetradecane, toluene, xylene, mesitylene, methanol, ethanol, propanol, butanol, pentanol, hexanol, acetone, methyethylketone, tetrahydrofuran; dichloromethane, chlorobenzene; dichlorobenzene; trichlorobenzene; nitrobenzene; cyanobenzene; N,N-dimethylformamide, acetonitrile; or mixtures thereof.

The substrate upon which the silver features are printed may be any suitable substrate, including, for example, silicon, glass plate, plastic film, sheet, fabric, or paper. For structurally flexible devices, plastic substrates, such as for example polyester, polycarbonate, polyimide sheets and the like may be used. The thickness of the substrate may be from amount 10 micrometers to over 10 millimeters with an exemplary thickness being from about 50 micrometers to about 2 millimeters, especially for a flexible plastic substrate and from about 0.4 to about 10 millimeters for a rigid substrate such as glass or silicon.

In yet other embodiments, there is provided a thin film transistor comprising:
(a) an insulating layer;
(b) a gate electrode;
(c) a semiconductor layer;
(d) a source electrode; and
(e) a drain electrode,

wherein the insulating layer, the gate electrode, the semiconductor layer, the source electrode, and the drain electrode are in any sequence as long as the gate electrode and the semiconductor layer both contact the insulating layer, and the source electrode and the drain electrode both contact the semiconductor layer, and

wherein at least one of the source electrode, the drain electrode, and the gate electrode are formed by: providing two or more solutions, wherein a first solution is a silver compound solution and a second solution is a hydrazine compound reducing agent solution comprised of a hydrazine compound for the silver compound, the hydrazine compound reducing agent solution being separate from the silver compound solution; printing the silver compound solution and the hydrazine compound reducing agent solution onto the substrate with a printhead, wherein just before printing, during printing, or following the printing of both the silver compound solution and the hydrazine compound reducing agent solution onto the substrate, the silver compound solution and the hydrazine compound reducing agent solution are combined; and reducing the silver compound to form the printed silver feature on the substrate.

A gate electrode, a source electrode, and a drain electrode may thus be fabricated by embodiments herein. The thickness of the gate electrode layer ranges for example from about 10 to about 2000 nm. Typical thicknesses of source and drain electrodes are, for example, from about 40 nm to about 1 micrometer with the more specific thickness being about 60 nanometers to about 400 nm.

The insulating layer generally can be an inorganic material film or an organic polymer film. Examples of inorganic materials suitable as the insulating layer may include, for example, silicon oxide, silicon nitride, aluminum oxide, barium titanate, barium zirconium titanate and the like. Illustrative examples of organic polymers for the insulating layer may include, for example, polyesters, polycarbonates, poly(vinyl phenol), polyimides, polystyrene, poly(methacrylate)s, poly(acrylate)s, epoxy resin and the like. The thickness of the insulating layer is, for example from about 10 nm to about 500 nm depending on the dielectic constant of the dielectric material used. An exemplary thickness of the insulating layer is from about 100 nm to about 500 nm. The insulating layer may have a conductivity that is, for example, less than about 10-12 S/cm.

Situated, for example, between and in contact with the insulating layer and the source/drain electrodes is the semiconductor layer wherein the thickness of the semiconductor layer is generally, for example, about 10 nm to about 1 micrometer, or about 40 to about 100 nm. Any semiconductor material may be used to form this layer. Exemplary semiconductor materials include regioregular polythiophene, oligthiophene, pentacene, and the semiconductor polymers disclosed in U.S. Publication No. 2003/0160230 A1; U.S. Publication No. 2003/0160234 A1; U.S. Publication No. 2003/0136958 A1; the disclosures of which are totally incorporated herein by reference. Any suitable technique may be used to form the semiconductor layer. One such method is to apply a vacuum of about 10⁻⁵ torr to 10⁻⁷ torr to a chamber containing a substrate and a source vessel that holds the compound in powdered form, and heat the vessel until the compound sublimes onto the substrate. The semiconductor layer can also generally be fabricated by solution processes such as spin coating, casting, screen printing, stamping, or jet printing of a solution or dispersion of the semiconductor.

The insulating layer, the gate electrode, the semiconductor layer, the source electrode, and the drain electrode are formed in any sequence, particularly where in embodiments the gate electrode and the semiconductor layer both contact the insulating layer, and the source electrode and the drain electrode both contact the semiconductor layer. The phrase “in any sequence” includes sequential and simultaneous formation. For example, the source electrode and the drain electrode can be formed simultaneously or sequentially. The composition, fabrication, and operation of thin film transistors are described in U.S. Pat. No. 6,107,117, the disclosure of which is totally incorporated herein by reference.

Embodiments will now be further described in detail with respect to specific embodiments thereof, it being understood that these examples are intended to be illustrative only. All percentages and parts are by weight unless otherwise indicated.

### EXAMPLE 1

### Formation of Silver Compound Solution and Hydrazine Compound Solution

An aqueous solution of silver nitrate (Solution A) was prepared by dissolving 20 grams of silver nitrate into 80 grams of de-ionized water and filtering the solution with a 0.2 micrometer glass syringe filter. Separately, a separate aqueous solution (Solution B) comprised of 20 grams of phenylhydrazine and 80 grams of ethanol was prepared and subsequently filtered with a 0.2 micrometer glass syringe filter.

### Printing on a Substrate and Annealing to Form Conductive Silver Patterns

Solution A and Solution B are placed into two separated cartridges of an inkjet printer and printed in a designed pattern onto a glass substrate by printing 1) Solution A and 2) printing Solution B on directly on top of the pattern where Solution A was printed. The glass substrate is then heated on a hotplate to a temperature of 100° C. tor 30 minutes and cooled. Inspection confirmed the formation of conductive silver patterns on the surface of the glass substrate.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A method of forming a conductive silver feature on a substrate, the method comprising:
providing two or more solutions, wherein a first solution is a silver compound solution and a second solution is a reducing agent solution comprised of a hydrazine compound, the reducing agent solution being separate from the silver compound solution;
printing the silver compound solution and the reducing agent solution onto the substrate with a printhead, wherein just before printing, during printing, or following the printing of both the silver compound solution and the reducing agent solution onto the substrate, the silver compound solution and the reducing agent solution are combined; and
reducing the silver compound to form the printed silver feature on the substrate.

2. A method according to claim 1, wherein the silver compound solution is comprised of a silver compound of silver oxide, silver nitrate, silver nitrite, silver carboxylate, silver acetate, silver carbonate, silver perchlorate, silver sulfate, silver chloride, silver bromide, silver iodide, silver trifluoroacetate, silver phosphate, silver trifluoroacetate, silver benzoate, silver lactate or combinations thereof.

3. A method according to claim 1, wherein the concentration of the silver compound in the silver compound solution is from about 5 weight percent to about 80 weight percent.

4. A method according to claim 1, wherein the hydrazine compound in the reducing agent solution is a hydrocarbyl hydrazine, a hydrazide, a carbazate, a sulfonohydrazide, or combinations thereof.

5. A method according to claim 1, wherein the concentration of the hydrazine compound in the reducing agent solution is from about 1 weight percent to about 100 weight percent.

6. A method according to claim 1, wherein the silver compound solution and the reducing agent solution are mixed just before printing and are printed together onto the substrate from a same printhead.

7. A method according to claim 1, wherein the silver compound solution and the reducing agent solution are mixed during the printing of both the silver compound solution and the reducing agent solution on the substrate by simultaneously printing both solutions onto the substrate from a same or different printhead.

8. A method according to claim 1, wherein the silver compound solution and the reducing agent solution are mixed after printing both the silver compound solution and the reducing agent solution on the substrate by first printing one of the solutions onto the substrate and thereafter subsequently printing the other solution onto the first printed solution.

9. A method according to claim 1, wherein the substrate is comprised of silicon, glass, metal oxide, plastic, fabric, paper or combinations thereof.

10. A method according to claim 1, wherein the substrate is comprised of plastic.

11. A method according to claim 1, wherein the method further comprises heating the printed substrate to from about 40° C. to about 180° C. following printing.

12. A method according to claim 1, wherein the method further comprises washing the printed silver feature with a solvent.

13. A method of forming a conductive silver feature on a substrate, the method comprising:
providing two or more solutions. wherein a first solution is a silver compound solution and a second solution is a reducing agent solution comprised of a hydrazine compound for the silver compound, the reducing agent solution being separate from the silver compound solution;
just before printing the silver compound solution and the reducing agent solution onto the substrate, the silver compound solution and the reducing agent solution are combined;
printing the combined solutions onto the substrate with a printhead; and
reducing the silver compound to form the printed silver feature on the substrate.

14. A method according to claim 13, wherein the silver compound solution is comprised of a silver compound of silver oxide, silver nitrate, silver nitrite, silver carboxylate, silver acetate, silver carbonate, silver perchlorate, silver sulfate, silver chloride, silver bromide, silver iodide, silver trifluoroacetate, silver phosphate, silver trifluoroacetate, silver benzoate, silver lactate or combinations thereof.

15. A method according to claim 13, wherein the hydrazine compound in the reducing agent solution is a hydrocarbyl hydrazine, a hydrazide, a carbazate, a sulfonohydrazide, or combinations thereof.

16. A method according to claim 13, wherein the silver compound solution and the reducing agent solution are reacted together in a microfluid reactor just before printing, transferred to a printhead and are printed together onto the substrate by a printhead.

17. A method according to claim 13, wherein following the printing, the method further comprises heating the printed substrate to from about 40° C. to about 180° C.

18. A method of forming a conductive silver feature on a substrate, the method comprising:
providing two or more solutions, wherein a first solution is a silver compound solution and a second solution is a reducing agent solution comprised of a hydrazine compound for the silver compound, the reducing agent solution being separate from the silver compound solution;
printing the silver compound solution and the reducing agent solution onto the substrate with a printhead, wherein during printing or following the printing of both the silver compound solution and the reducing agent solution onto the substrate, the silver compound solution and the reducing agent solution are combined; and
reducing the silver compound to form the printed silver feature on the substrate.

19. A method according to claim 18, wherein the silver compound solution is comprised of a silver compound of silver oxide, silver nitrate, silver nitrite, silver carboxylate, silver acetate, silver carbonate, silver perchlorate, silver sulfate, silver chloride, silver bromide, silver iodide, silver trifluoroacetate, silver phosphate, silver trifluoroacetate, silver benzoate, silver lactate or combinations thereof.

20. A method according to claim 18, wherein the hydrazine compound in the reducing agent solution is a hydrocarbyl hydrazine, a hydrazide, a carbazate, a sulfonohydrazide, or combinations thereof.

21. A method according to claim 18, wherein the silver compound solution and the reducing agent solution are combined during the printing of both the silver compound solution and the reducing agent solution onto the substrate by simultaneously printing both solutions onto the substrate from the same or different printhead.

22. A method according to claim 18, wherein the silver compound solution and the reducing agent solution are combined after printing both the silver compound solution and the reducing agent solution on the substrate by first printing one of the solutions onto the substrate and thereafter subsequently printing the other solution onto the first printed solution.

23. A method according to claim 18, wherein following the printing, the method further comprises heating the printed substrate to from about 40° C. to about 180° C.
